(19) United States
(12) Patent Application Publication
(10) Pub. No.: US 2015/0223404 A1
(43) Pub. Date: Aug. 13, 2015

(54) Modular Plant Container System

(71) Applicant: Jim Denis Riley, Cardiff, CA (US)

(72) Inventor: Jim Denis Riley, Cardiff, CA (US)

(21) Appl. No.: 14/176,269

(22) Filed: Feb. 10, 2014

(51) Int. Cl. A01G 9/02

(52) U.S. Cl. CPC A01G 9/02; A01G 9/021

(57) ABSTRACT

A modular plant container system is disclosed for displaying and providing life support and mechanical support for live, synthetic, and rootless plants. The system includes a primary container, a subcontainer intended to contain life supporting elements such as nutrients, soil, and moisture, and a removable structure that engages with the primary container and the subcontainer to support the trunks of rootless plants such as live Christmas trees or top heavy synthetic plants. Said removable structure is configured to support a wide variety of trunk sizes be easily installed or removed from said primary container.

### FIELD OF THE INVENTION

The field of the invention is containers for holding live or synthetic plants for display or sale, as well as containers that provide life support and mechanical support for plants such as Christmas trees that have been severed from their roots.

### BACKGROUND

Virtually everyone has both indoor and outdoor plants in their homes or workplaces. The containers that these flora are typically sold in are plastic buckets. The plants—after purchase—are usually transferred to a more aesthetically pleasing container, which may be plastic, wood, metal, pottery, or another form of soil, moisture, and nutrient container that helps keep the plant alive.

Millions of Christmas trees are severed from their roots and sold to customers who hope that they last a few weeks until the Christmas season is over. Special support mechanisms are offered with these trees to keep them upright during their intended use period. These devices typically consist of at least three horizontal struts extending from a circular frame with several screws that can be tightened to clamp the tree trunk in a substantially vertical position so the tree can remain stable on a floor. There are also various nutrient retaining solutions that are applied to the severed tree trunk to extend its useful life and keep the branches from drying out. The support mechanisms are often covered with decorative cloth or other camouflage since they are generally functional rather than aesthetic.

There is also a growing supply of synthetic Christmas trees offered for sale. These trees are usually supplied with a very basic support structure that is typically shrouded with an aesthetic medium of the customer's choosing.

Often, a live plant may be temporarily moved from its preferred location in a home to make room for either a Christmas tree with severed roots or a synthetic Christmas tree. After the holiday season, the Christmas tree is moved to a storage location or to the trash.

There are more and more synthetic plants of many genuses being made available to fill the need for natural feeling environments with challenging plant life support resources—as well to satisfy the environmental preferences of people who just can't keep real plants alive.

There is a need for a container system that can improve the aesthetic appearance of live plants for indoor and outdoor positioning, as well as provide life support for a live plant without spilling water and/or nutrient sources, and also display and provide life support for a tree with severed roots, or a top heavy synthetic plant. The present invention serves these needs.

### SUMMARY OF THE INVENTION

In the preferred embodiment of the present invention, an improved modular plant container system comprises a container having a base and a hollow enclosure extending upward from said base and being open at the top. Said first container may be formed from pieces of wood, molded from plastic, formed of metal, formed in clay, or formed from any other solid medium. Said first container may form a square, rectangular, cylindrical, or any other solid shape enclosure. Said first container is intended to provide aesthetic appeal.

A second container configured to nest within said first container also comprises a base with a hollow enclosure extending upward from said base and being open at the top. Said second container may be formed from pieces of wood, molded from plastic, formed of metal, formed in clay, or formed from any other solid medium. Said second container may form a square, rectangular, cylindrical, or any other solid shape enclosure, and is not as tall as said first container, its top edge being at least several inches shorter than the upper edge of said first container when said second container is placed within said first container. Said second container is intended to provide mechanical support for a live plant with or without roots and also retain water, soil, or nutrients to provide life support for said live plant.

A third container comprising a substantially “Criss-Cross” or “H” shaped space frame and a clamping system is provided which is designed to slide over a tree trunk which has been severed from its roots—such as a typically Christmas tree. Said third container may be formed from pieces of wood, molded from plastic, formed of metal, formed in clay, or formed from any other solid medium. Said third container may form a square, rectangular, cylindrical, or any other solid shape substantially “H” shaped space frame that may be clamped to said rootless tree trunk and nest within said first container.

The horizontal extremities of said third container rest against the inner walls of said first container and the lower surface of said third container rests against the upper edge of said second container. The clamping mechanism of said third container is configured with at least one threadably mounted shaft penetrating said third container in a substantially horizontal plane.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. All illustrations are intended to convey concepts, where relative sizes, shapes and other detailed attributes may be illustrated schematically, rather than literally or precisely. Moreover, in the figures, like reference numerals designate corresponding parts throughout the different views. However, like parts do not always have like reference numerals.

FIG. 1 is an illustration of an example embodiment of an improved modular plant container system.

FIG. 2 is an illustration of the major components nested together in an improved modular plant container system of FIG. 1

FIG. 3 is top view schematic of the major components of an improved modular plant container system of FIG. 1.

FIG. 4 is an isometric illustration of a support frame configuration of an improved modular plant container system of FIG. 1.

FIG. 4a is a top view schematic illustration of a support frame configuration of an improved modular plant container system of FIG. 1.

FIG. 5 is an isometric illustration of an alternative support frame configuration of an improved modular plant container system of FIG. 1.

FIG. 5a is a top view schematic illustration of an alternative support frame configuration of an improved modular plant container system of FIG. 1.

FIG. 6 is an illustration of an improved modular plant container system of FIG. 1 containing a rootless tree and life support elements.

FIG. 7 is an illustration of an improved modular plant container system of FIG. 1 containing a rootless tree and life support elements as well as a riser.

### DETAILED DESCRIPTION OF THE PREFERRED EMBODIMENTS

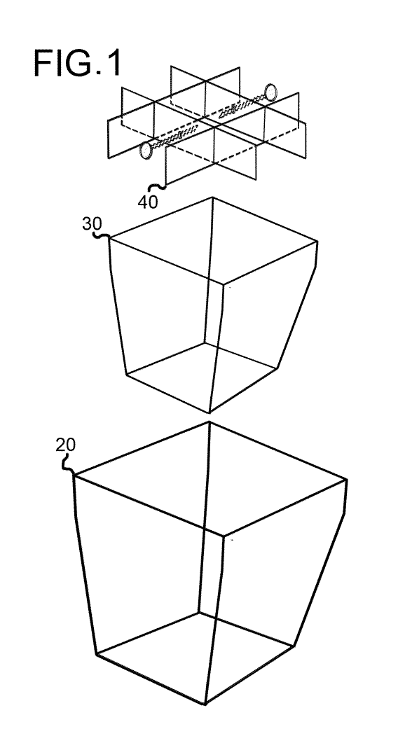

The attached drawing figures share common numerals where appropriate, and for simplicity and clarity certain figures have fewer numerals to avoid confusion. For example, in FIG. 1, only the three basic key component numerals are provided. In the remaining figures additional numerals are added as the element details of said key components require.

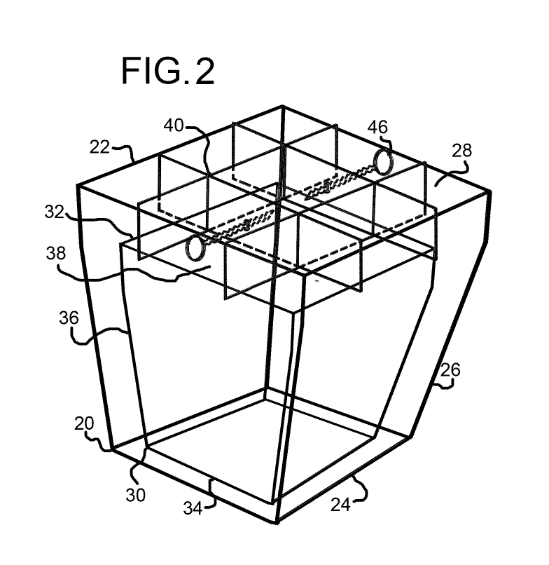

In the example embodiment shown in FIG. 1, the improved container system as disclosed herein comprises three primary elements including a first container 20, a second container 30, and a support frame 40. As shown in FIG. 2, said first container 20 has a top edge 22, a base 24, walls 26, and an interior space 28. Said first container 20 and top edge 22, base 24, and walls 26 may be formed of separate parts or molded as one piece. Said first container 20 may be formed from pieces of wood, molded from plastic, formed of metal, formed in clay, or formed from any other solid medium. Said first container 20 may form a square, rectangular, cylindrical, or any other solid shape enclosure. Said first container 20 is intended to provide aesthetic appeal and provide said interior space 28 within which the rest of the components disclosed herein might be placed.

Also as detailed in FIG. 2, a second container 30 is provided which also incorporates a top edge 32, a base 34, walls 36, and an interior space 38. Said second container 30 is intended to nest within said first container 20. Said second container may be formed from pieces of wood, molded from plastic, formed of metal, formed in clay, or formed from any other solid medium. Said second container 30 may form a square, rectangular, cylindrical, or any other solid shape enclosure, and is not intended to be as tall as said first container 20.

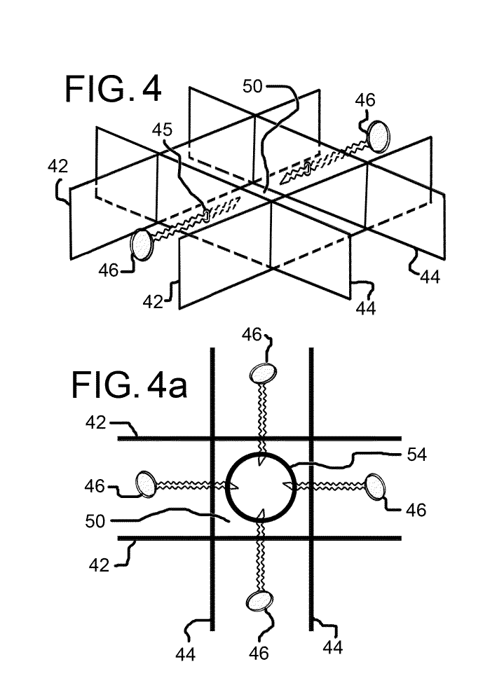

As presented in FIG. 1, and further detailed in FIG. 4 and FIG. 4a, tree trunk support frame 40 is provided with a pair of x-axis arms 42 and a pair of y-axis arms 44 configured in a criss-cross manner at substantially ninety degrees to each other. Said arms 42 and 44 may be fabricated from separate pieces of solid material such as wood, metal, plastic, or any other solid material, or said arms 42 and 44 may also be formed from an extruded or molded plastic, metal, or other solid material. As further shown in FIG. 4 and FIG. 4a, in a preferred embodiment of said support frame 40, said arms 42 and 44 define a z-axis height sufficient to provide a tree trunk clamping zone 50. Said clamping zone 50 includes at least one tensioning screw 46 which threadably breaches said clamping zone 50 through a mid point of said clamping area 50 through at least one threaded hole 45 in said arms 42 and 44 in a manner substantially parallel to said arms 42 or 44. Ideally said clamping zone 50 will incorporate a plurality of said tensioning screw 46 and threaded hole 45.

For ease of design understanding in FIG. 1 through FIG. 7, said first container 20, and second container 30 are drawn as transparent elements, whereas said tree trunk support frame 40 incorporates dashed lines to indicate hidden structural elements.

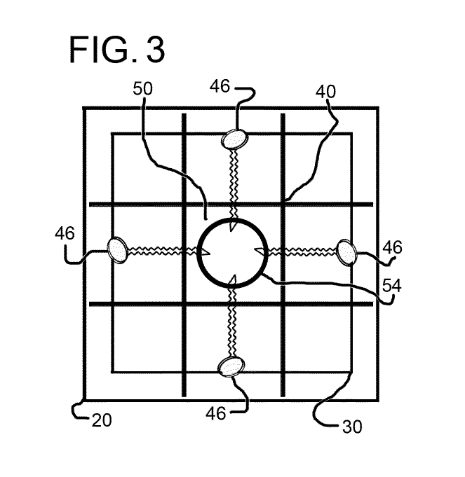

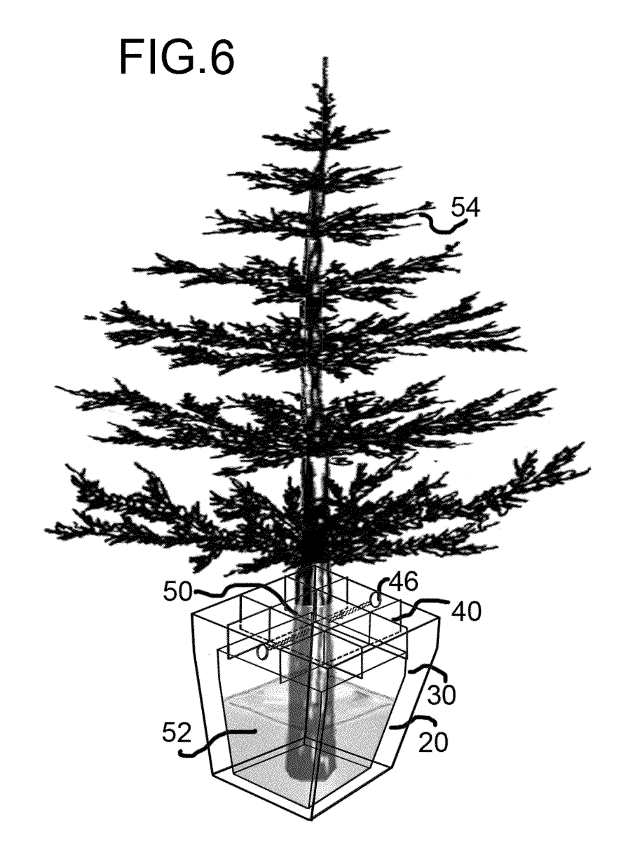

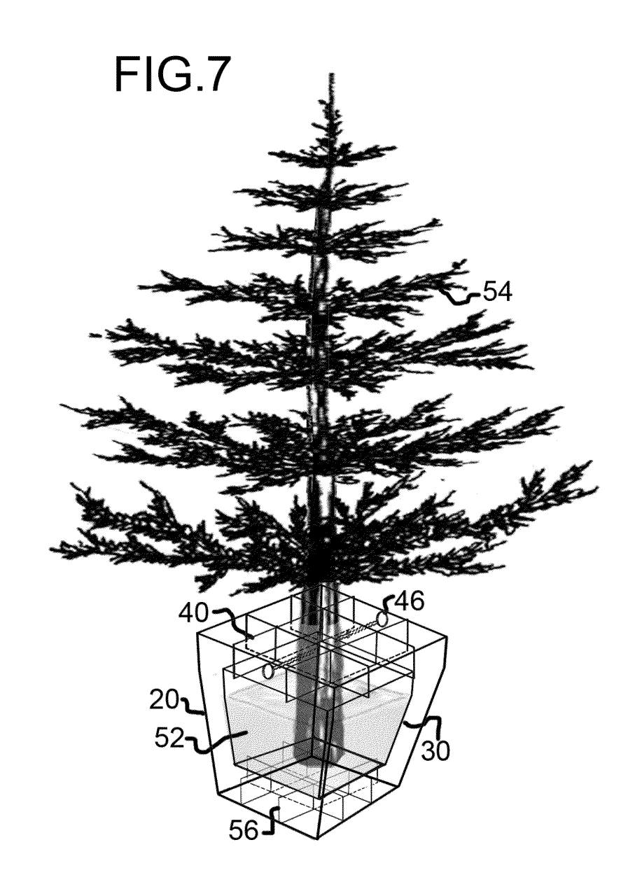

The length and height of said arms 42 and 44 may be of any size provided that the extreme x-axis and y-axis edges of said arms 42 and 44 make contact with the inner walls 28 of said container 20 when said support frame 40 is resting on said top edge 32 of said second container 30 when said second container 30 is nested inside said first container 20 as presented in FIG. 2, FIG. 3, FIG. 6, and FIG. 7.

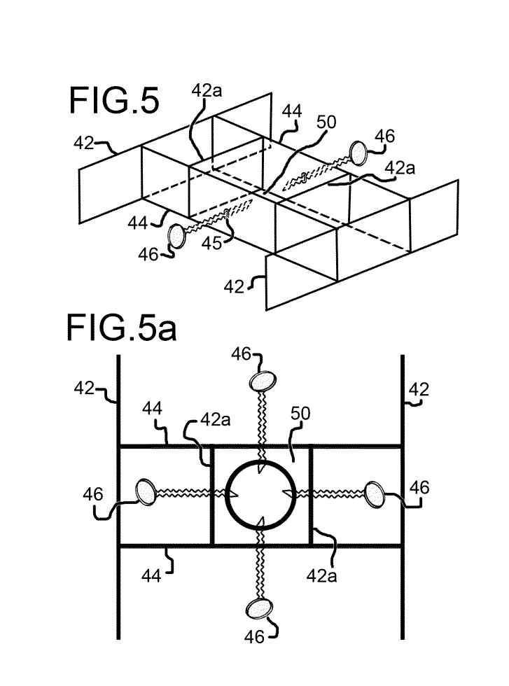

As further detailed in FIG. 5 and FIG. 5a, another embodiment of said support frame 40 may provide arms 42 located at the extreme ends of arms 44 and a pair of truncated additional y-axis arms 42a may be included to form said tree trunk clamping zone 50. As further shown in FIG. 2, the preferred embodiment of the support frame 40 in this configuration includes at least one tensioning screw 46 which threadably breaches said clamping zone 50 through a mid point of said clamping area 50 through at least one threaded hole 45 in said arms 42 and 42a in a manner substantially parallel to said arms 42, 42a, or 44. The length and height of said arms 42 and 44 may be of any size provided that the extreme x-axis and y-axis edges of said arms 42 make contact with the inner walls 28 of said container 20 when said support frame 40 is resting on said top edge 32 of said second container 30 when said second container 30 is nested inside said first container 20.

As presented in FIG. 6, second container 30 is intended to provide a water and nutrients combination 52 or other life supporting compounds that may be transpired through the trunk of a rootless plant such as a Christmas Tree or other live plant 54, which has been removed from its natural environment.

As presented in FIG. 7, a riser 56 may be placed below said second container 30 to compensate for a shorter live plant 54 trunk. Said riser 56 is essentially identical to said support frame 40 except that it has no tensioning screw 46 installed. Said riser 56 may be smaller than support frame 40 if required or identical in size and shape if that configuration serves the height and support requirements of said live plant 54. Said riser 56 incorporates dashed lines to indicate hidden structural elements.

The parts of the modular container system presented in FIG. 1 through FIG. 7 may be injection molded, blow molded, or vacuum molded out of a plastic, formed from wood parts fastened together, welded from metal parts, cast from a variety of solid materials, or otherwise fabricated to effectively define the components and functions described herein. The shape and size of second container 30, support frame 40, and clamping zone 50 may be any shape and size that are appropriate for a given trunk diameter of a live plant 54. For example, said first container 20, second container 30, support frame 40, and clamping zone 50 may be tapering or non-tapering cylindrical, rectangular, triangular, hexagonal, truncated trapezoid, or any other geometric forms.

Although both synthetic plant and Christmas Tree frames are currently offered that can hold a given amount of life supporting elements to provide life support for a Christmas Tree effectively, no prior art live plant container system has been disclosed that is configured in a modular fashion such that a decorative first container 20 housing a second container 30 containing a live plant with roots, may allow said second container 30 to be easily removed and replaced with another second container 30 and a support frame 40 combination wherein said second container 30 holds a water and nutrients combination 52, and said first container 20, second container 30, and support frame 40 in combination provide mechanical support for a synthetic plant or both mechanical and life support for a rootless live plant 54.

In the foregoing specification, the invention has been described with reference to specific embodiments thereof. It will, however, be evident that various modifications and changes may be made thereto without departing from the broader spirit and scope of the invention. For example, the reader is to understand that the diagrams described herein are merely illustrative and that each feature of one embodiment can be mixed and matched with other features shown in other embodiments. Features and processes known to those of ordinary skill in the art of live plant containers may similarly be incorporated as desired. Additionally and obviously, features may be added or subtracted as desired. Accordingly, the invention is not to be restricted except in light of the attached claims and their equivalents.

What is claimed is:

1. A modular plant container system comprising: a first container having a top edge and a base, and walls defining an interior space, and being open at the top; a second container configured to nest within said first container and also having a top edge and a base, and walls defining an interior space, and being open at the top, said second container having a top edge shorter than the upper edge of said first container when said second container is placed within said first container, a third container comprising a space frame having height, width, and length; said third container incorporating a clamping system designed to slide over and apply pressure to a live or synthetic rootless tree trunk; wherein said third container provides mechanical support for said rootless tree trunk by nesting within said first container with the horizontal extremities of said third container resting against the inner wall surfaces of said first container and the lower edge of said third container resting against the upper edge of said second container.

2. A modular plant container system according to claim 1 wherein said second container provides life support for said live plant by retaining water, soil, or nutrients.

3. A modular plant container system according to claim 1 fabricated out of wood, plastic, metal, or any other solid material.

4. A modular plant container system according to claim 1 made of any geometric shape.
